(19) United States
(12) Patent Application Publication
(10) Pub. No.: US 2019/0093413 A1
(43) Pub. Date: Mar. 28, 2019

(54) DRIVING DEVICE FOR ELECTRIC SLIDING DOORS

(71) Applicant: QUANTUM PRECISION INDUSTRIAL CO., LTD., CHANGHUA CITY (TW)

(72) Inventor: Fu-Chih Lee, CHANGHUA CITY (TW)

(21) Appl. No.: 16/128,470

(22) Filed: Sep. 11, 2018

(30) Foreign Application Priority Data
Sep. 22, 2017 (TW) 106132575

(51) Int. Cl. E05F 15/643; E05F 15/70; E05D 15/06

(52) U.S. Cl. CPC E05F 15/643; E05F 15/70; E05D 2015/1026; E05Y 2201/446; E05D 15/06

(57) ABSTRACT

A driving device for electric sliding doors has: a track, a driving unit, a gliding member, and a door panel. The track has a first groove and a second groove, the driving unit is mounted on the first of the track Inside the groove and has a circuit board and two electromagnet sets connected to both sides of the circuit board. The gliding member is disposed in the second groove, and the gliding member is arranged in the order facing the driving unit, and the door panel is fixed to the bottom of the gliding member by the track. The electric door system of the present invention controls the magnetic pole change of the electromagnet sets through the circuit board, and utilizes the characteristics of the magnetic poles to move the magnetic member of the gliding member, such that the mechanical mechanism of the electric door can have silent operation.

### BACKGROUND OF INVENTION

### 1. Field of Invention

The present invention relates to a driving device for electric doors, and more particularly to a driving device having electromagnetics.

### 2. Description of the Related Art

As shown in FIG. 7, a conventional electric door 50 has a positioning seat 51, a driving motor 52 mounted on one end of the positioning base 51, and a driving wheel 53 driven by the driving motor 52. Another end of the positioning base 51 is further provided with a driven wheel 54, and a rotating belt 55 is disposed between the driving wheel 53 and the driven wheel 54. The belt 55 is hooked with a plurality of sliders 56 to be attached onto a door panel 57. Thereby, the driving wheel 53 is driven to rotate by the driving motor 52, and then the belt 55 rotates around the driving wheel 53 and the driven wheel 54 to move the sliders 56 to achieve the purpose of automatically opening and closing the door panel.

However, it is not difficult to find out that the above-mentioned conventional structure has some shortcomings as follows: the movement of the conventional electric door is achieved when the belt 55 driven by the drive motor 52 creates the displacement of the sliders 56. But due to the transmission ratio of the belt 55 and the transmission wheel 53 is 1 to 1, the winding range of the belt 55 is equivalent to the opening and closing ranges of the door panel 57, which greatly increases the structural cost and has no economic benefit. Furthermore, the door panel 57 is completely driven by the mechanical mechanism which produces noise, and the large structure and the installation are very inconvenient.

Therefore, it is desirable to provide a driving device for electric doors to mitigate and/or obviate the aforementioned problems.

### SUMMARY OF THE INVENTION

An objective of present invention is to provide a driving device for electric doors, which is capable of improving the above-mention problems.

In order to achieve the above mentioned objective, A driving device for electric sliding doors has: a track, a driving unit, a gliding member, and a door panel. The track has a first groove and a second groove, the driving unit is mounted on the first of the track Inside the groove and has a circuit board and two electromagnet sets connected to both sides of the circuit board. The gliding member is disposed in the second groove, and the gliding member is arranged in the order facing the driving unit, and the door panel is fixed to the bottom of the gliding member by the track.

Other objects, advantages, and novel features of invention will become more apparent from the following detailed description when taken in conjunction with the accompanying drawings.

### BRIEF DESCRIPTION OF DRAWINGS

FIG. 1 is a perspective view of a preferred embodiment according to the present invention.

FIG. 2 is an exploded view of the preferred embodiment according to the present invention.

FIG. 3 is a cross-sectional view and a partial enlarged view of the preferred embodiment according to the present invention.

FIG. 4 is a schematic view showing the driving unit of the preferred embodiment according to the present invention.

FIG. 5 is an operation drawing of the driving displacement of the preferred embodiment according to the present invention.

FIG. 6 is a schematic drawing of the displacement of the door panel along the track according to the preferred embodiment of the present invention.

FIG. 7 is a schematic drawing of a conventional structure.

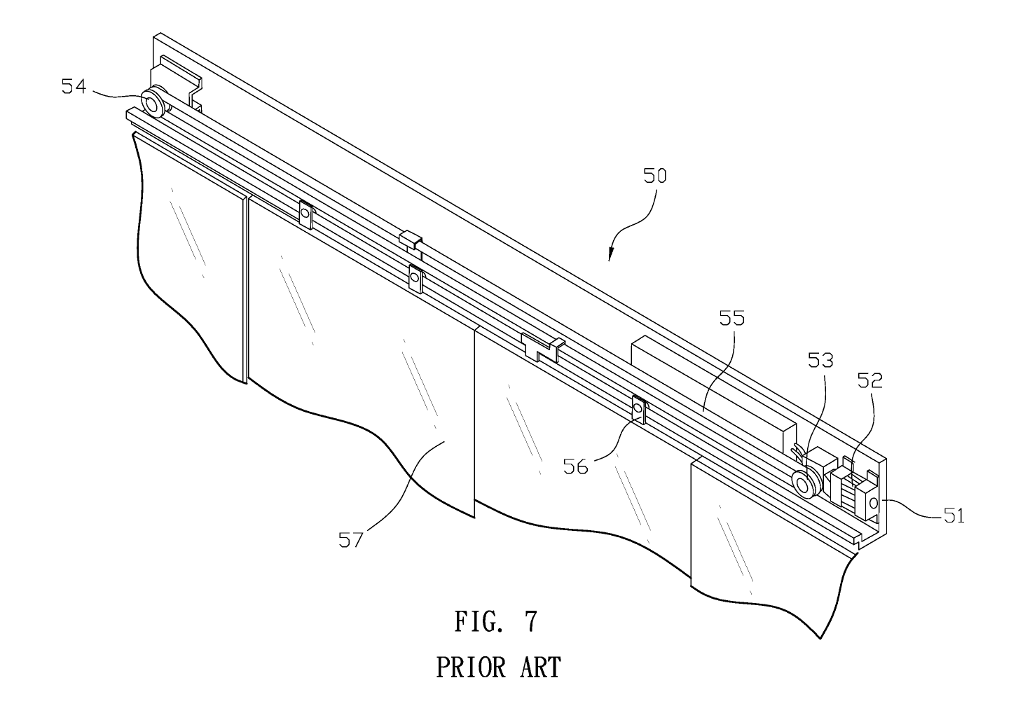

### DETAILED DESCRIPTION OF THE PREFERRED EMBODIMENT

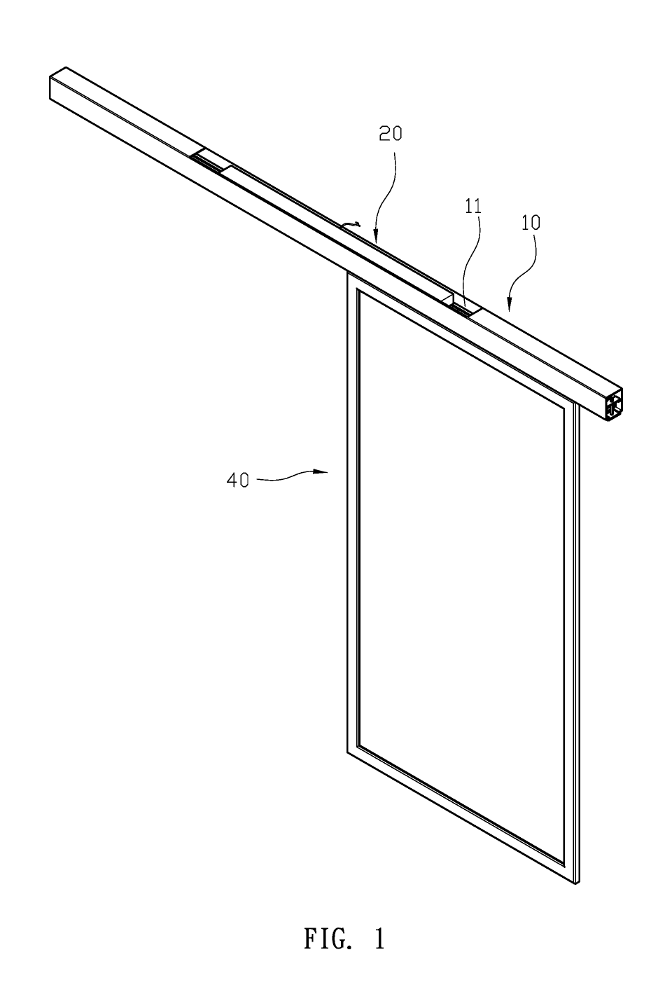

Please refer to FIGS. 1, 2 and 3. A gliding member driving device for electric sliding doors comprises: a track 10, a driving unit 20, a gliding member 30 and a door panel 40. The track has a first groove 11 and a second groove 12 parallel with each other, both ends of the second groove 12 respectively have a stopping block 13, and the second groove 12 further is provided with a connecting opening 14 at its bottom. The driving unit 20 is mounted in the first groove 11 of the track 10 and comprises a circuit board 21 and two electromagnet sets 22 respectively connected to two sides of the circuit board 21. Each electromagnet set comprises a plurality of magnet windings 221 which generate magnetic poles corresponding to the direction of the current on the circuit board 21. The gliding member 30 is disposed in the second groove 12 and has a plurality of pulley wheel sets 31 respectively at a front and rear end along the second groove 12. More pulley wheel sets can be added for the longer gliding member 30. Furthermore, the pulley wheel 31 is provided with a bearing for smooth movement. A plurality of magnetic members 32 facing the driving unit are disposed on the gliding member 30 with a same magnetic pole arrangement. A door panel 40 is mounted at the bottom of the gliding member 30 through the connecting opening 14 of the track 10.

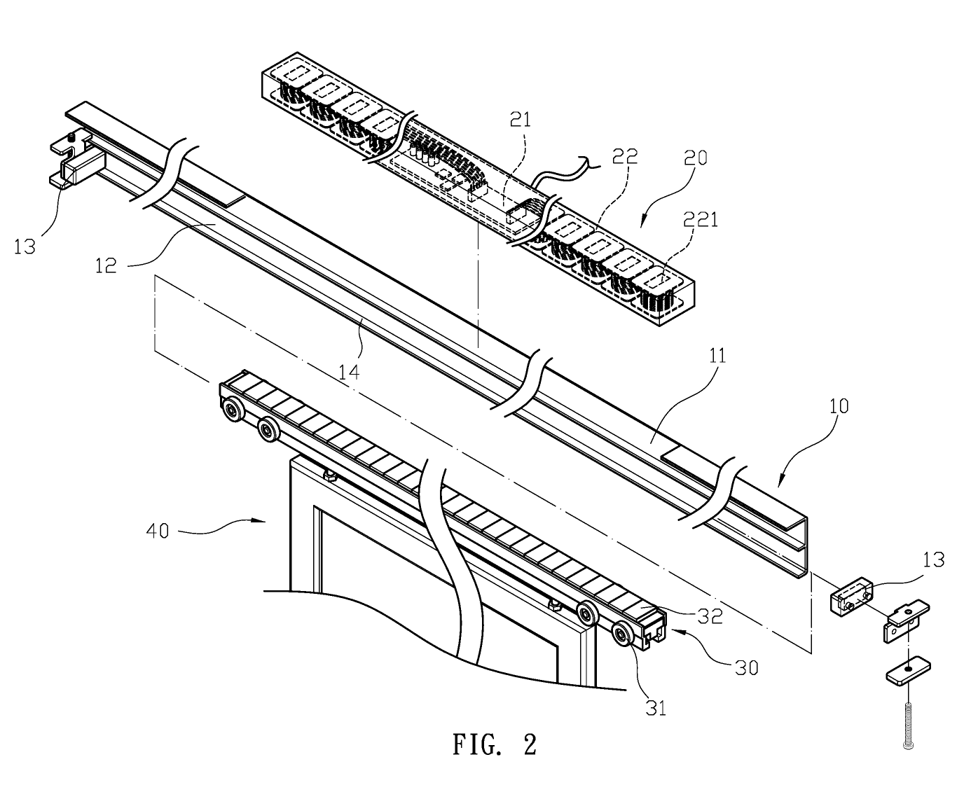

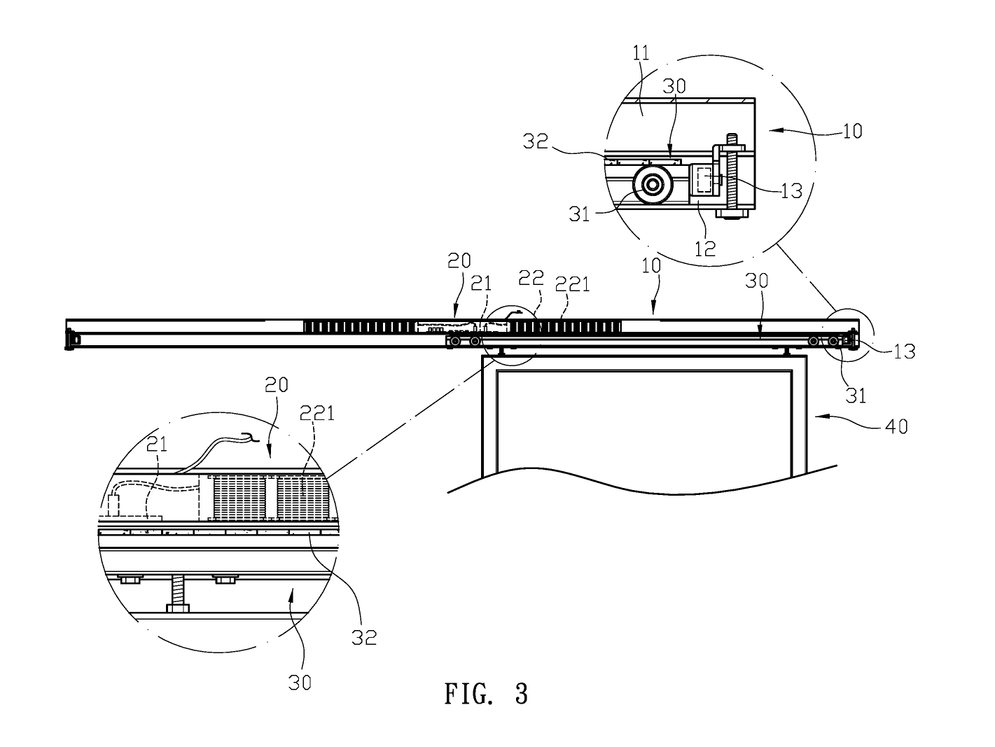

Please refer to FIG. 2 and FIG. 3. The driving unit 20 is mounted onto the first groove 11 of the track 10, and the two electromagnet sets 22 of the driving unit 20 are connected to two sides of the circuit board 21. The circuit board 21 is provided with a sensing device (not shown) to sense the opening and closing signal, and then the circuit board 21 controls the magnet winding 221 of the electromagnet set 22 to have a magnetic pole change. The second groove 12 of the track 10 is provided with the gliding member 30, the gliding member 30 is accommodated in the second groove 12. With the sliding movement of the pulley wheel 31, since the door panel 40 is connected to the bottom of the gliding member 30 through the connecting opening 14, the displacement of the gliding member 30 in the track 10 achieves the opening and closing of the door panel.

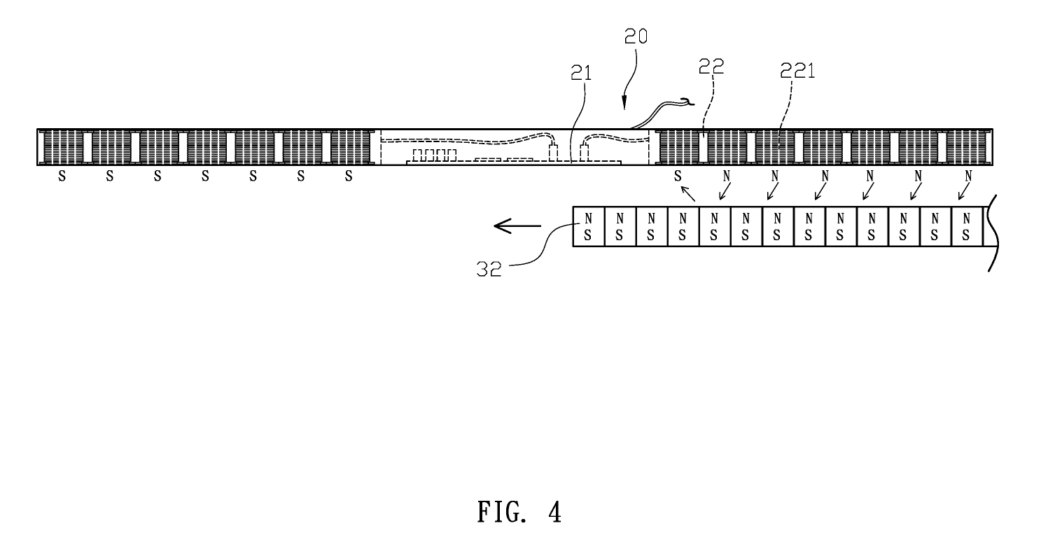

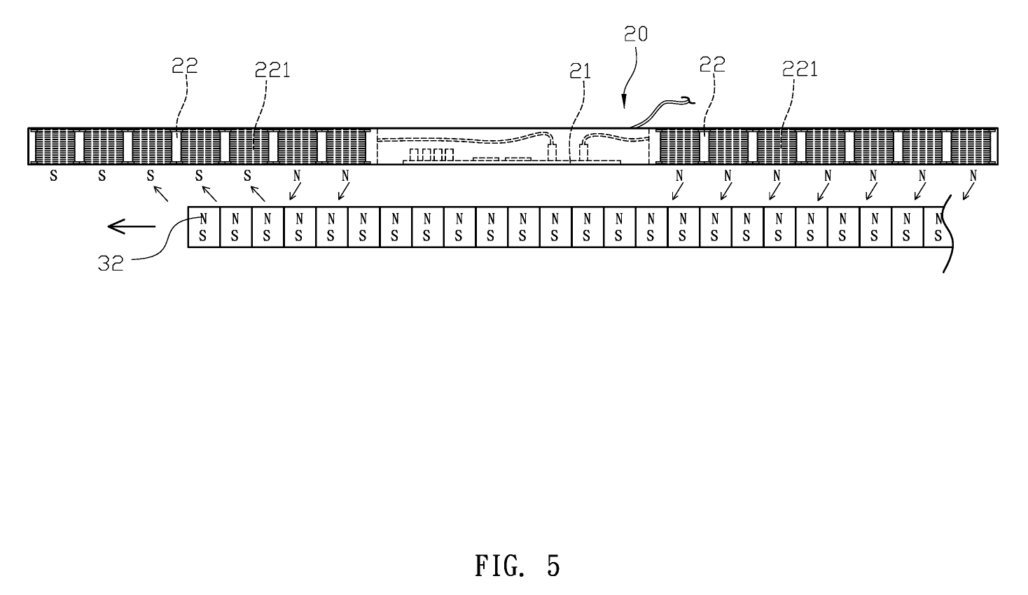

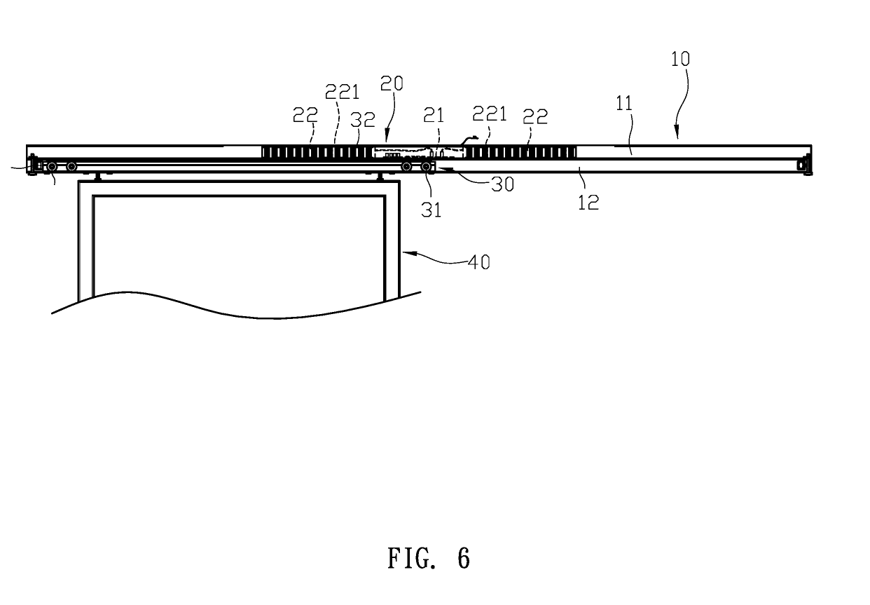

The actual use of the structure, as shown in FIGS. 3, 4, 5, and 6, the driving unit 20 controls magnetic pole change of each magnet winding 221 of the two electromagnet set 22 through the circuit board 21. When the magnetic pole of the magnet winding 221 is the same as the magnetic member 32, a repulsive effect is generated, and the magnetic pole of the magnet windings 221 along the sliding direction are set differently from the magnetic pole of the magnetic member 32 consequently, thereby generating an attractive force. When the gliding member 30 is subjected to the repulsive effect of the same magnetic pole between the magnet winding 221 and the magnetic member 32, it is attracted by the subsequent magnet winding 221 having the opposite magnetic pole, and the magnetic pole of the following magnet windings 221 is sequentially changed to having the opposite magnetic pole than the gliding member 30 to achieve the open and close of the door panel 40. For the first operation of the electric door, the gliding member 30 moves back and forth in the second groove 12, the stopping blocks 13 at both ends of the second groove 12 limit the displacement, while the driving unit 20 senses the stop timing of the gliding member 30 to obtain a slip path for a preferred frequency of change of the magnetic pole to facilitate adjustment of the displacement speed of the gliding member 30. Therefore, during the follow operation, the two electromagnet sets 22 can provide better timing of magnetic pole change along with the second groove 12. When the gliding member 30 arrives at both ends, the number of the magnet windings 221 having the opposite magnetic poles is increased, and the number of the magnet windings 221 having the same magnetic poles can be reduced to provide buffer effect and avoid direct impact on the stopping block 13 causing noise.

With the structure of the above specific embodiment, the following benefits can be obtained: the electric door system of the present invention controls the magnetic pole change of the electromagnet sets 22 through the circuit board 21, and utilizes the characteristics of the magnetic poles to move the magnetic member 32 of the gliding member 30, which achieves the door panel 40 to slide open and close. Furthermore, the mechanical mechanism of the electric door can have silent operation. Moreover, the driving unit 20 has simple assembly which greatly reduces the cost of the driving unit 20 and provides convenient installation.

Although the present invention has been explained in relation to its preferred embodiment, it is to be understood that many other possible modifications and variations can be made without departing from the spirit and scope of invention as hereinafter claimed.

What is claimed is:

1. A driving device for electric sliding doors comprising:
a track having a first groove and a second groove parallel with each other, both ends of the second groove respectively having a stopping block, and the second groove further provided with a connecting opening;
a driving unit mounted in the first groove of the track, comprising a circuit board and two electromagnet sets respectively connected to two sides of the circuit board, each electromagnet set comprising a plurality of magnet windings;
a gliding member disposed in the second groove, having at least one pulley wheel set respectively at a front and rear end, and a plurality of magnetic members facing the driving unit with a same magnetic pole arrangement; and
a door panel mounted at a bottom of the gliding member through the connecting opening of the track.

2. The driving device for electric sliding doors as claimed in claim 1, wherein the gliding member is configured to move along the second groove and limited by the stopping blocks, and the magnet windings of the driving unit sense movement of the gliding member.

3. The driving device for electric sliding doors as claimed in claim 1, wherein the each pulley wheel further comprises a bearing.

4. The driving device for electric sliding doors as claimed in claim 1, wherein the gliding member comprises a plurality of pulley wheel sets.

5. The driving device for electric sliding doors as claimed in claim 1, wherein the magnetic member is a permeant magnet.
